(19) United States
(12) Patent Application Publication
(10) Pub. No.: US 2010/0094777 A1
(43) Pub. Date: Apr. 15, 2010

(54) METHOD AND SYSTEM FOR PROVIDING AUTOMATIC EXECUTION OF RISK-CONTROLLED SYNTHETIC TRADING ENTITIES

(75) Inventors: Leslie Rosenthal, Chicago, IL (US); Benjamin D. Levine, Evanston, IL (US)

Correspondence Address: LESAVICH HIGH-TECH LAW GROUP, P.C., SUITE 325, 39 S. LASALLE STREET, CHICAGO, IL, 60603, US

(73) Assignee: Rosenthal Collins Group, LLC., Chicago, IL (US)

(21) Appl. No.: 12/618,100

(22) Filed: Nov. 13, 2009

Related U.S. Application Data
(63) Continuation-in-part of application No. 11/222,147, filed on Sep. 8, 2005, now Pat. No. 7,620,586.
Application No. 11/222,147 is a continuation-in-part of application No. 12/430,918, filed on Apr. 28, 2009.
(60) Provisional application No. 60/607,856, filed on Sep. 8, 2004.
(60) Provisional application No. 61/126,004, filed on Apr. 30, 2008.

(30) Foreign Application Priority Data
Sep. 8, 2005 (US) PCT/US2005/032189

(51) Int. Cl. G06Q 40/00; G06Q 50/00; G06F 3/048

(52) U.S. Cl. 705/36 R; 705/37; 715/781

(57) ABSTRACT

A method and system for automatic execution of risk-controlled synthetic trading entities. Risk parameters are generated for two or more real trading entities that comprise a synthetic trading entity. Risk assessments are generated for the resulting synthetic trading entity from the risk parameters. Current and historical trading information is used to generate the risk parameters and risk assessments. Market prices for the real trading entities to keep the automatic risk-controlled synthetic trading entity at a desired synthetic market price level whenever selected risk assessments exceed one or more pre-determined risk thresholds.

### CROSS REFERENCES TO RELATED APPLICATIONS

This Utility application is a Continuation-In-Part (CIP) of U.S. Utility application Ser. No. 11/222,147, filed Sep. 8, 2005, that claims priority to U.S. Provisional Patent Application 60/607,856, filed Sep. 8, 2004, that issued as U.S. Pat. No. 7,620,586, on Nov. 17, 2009, This application is a CIP of U.S. utility application Ser. No. 12/430,918, filed on Apr. 28, 2009, that claims priority to U.S. Provisional patent application 61/126,004, filed Apr. 30, 2008, the contents of all of which are incorporated by reference.

### FIELD OF THE INVENTION

This invention relates to providing electronic information over a computer network for electronic trading. More specifically, it relates to a method and system for providing automatic execution of trading strategies for electronic trading of actual and synthetic trading entities.

### BACKGROUND OF THE INVENTION

The trading of stocks, bonds and other financial instruments over computer networks such as the Internet has become a very common activity. In many countries of the world, such stocks, bonds and other financial instruments are traded exclusively over computer networks, completely replacing prior trading systems such as “open outcry” trading in trading pits.

Trading of stocks, bonds, etc. typically requires multiple types of associated electronic information. For example, to trade stocks electronically an electronic trader typically would like to know an asking price for a stock, a current bid price for a stock, a bid quantity, an asking quantity, current information about the company the trader is trading such as profit/loss information, a current corporate forecast, current corporate earnings, etc.

The multiple types of associated electronic information have to be supplied in real-time to allow the electronic trader to make the appropriate decisions. Such electronic information is typically displayed in multiple windows on a display screen.

For an electronic trader to be successful, the trader typically develops trading strategies. For example a trading strategy may include executing a trade based on a desired ratio between two trading instruments. As another example, a trading strategy may include executing a trade based on a basis level for a trading instrument.

There are several problems with using manual trading strategies on electronic trading systems. One problem is that a trader will typically create his/her own trading strategies using disjunct or proprietary tools. For example, a trade may implement his/her own trading strategy in a spreadsheet and manually enter and update current market values of trading instruments. The trader then must take additional actions to implement his/her trading strategy based on data form the spreadsheet.

Another problem is that some electronic trading systems allow traders to enter certain data to provide automatic notification of events that are related to a trader's trading strategy (e.g., a certain buy price, a sell price, a ratio, etc.). However, then a trader must still take manual actions to execute an electronic trade such as clicking a mouse, making a keyboard input, etc.).

Another problem is that many traders execute trades across many different markets and several different electronic exchanges. Such trading typically leads a trader to manual methods to execute a desired trading strategy.

Another problem is the display of spreads and options. Many GUIs do not display spreads and options.

Another problem is that most electronic trading systems do not allow creation or trading of synthetic contracts or synthetic instruments. As is known in the art, a “synthetic” instrument or contract includes one or more instruments or contracts that does not really exist on any electronic trading exchange.

Another problem is that electronic trading system do not provide adequate risk controls for trading synthetic trading entities.

There have been attempts to solve some of the problems with GUIs used for electronic trading. For example, U.S. Pat. No. 6,772,132 entitled “Click based trading with intuitive grid display of market depth” that issued to Kemp et al. teaches “A method and system for reducing the time it takes for a trader to place a trade when electronically trading on an exchange, thus increasing the likelihood that the trader will have orders filled at desirable prices and quantities. The “Mercury” display and trading method of the present invention ensure fast and accurate execution of trades by displaying market depth on a vertical or horizontal plane, which fluctuates logically up or down, left or right across the plane as the market prices fluctuates. This allows the trader to trade quickly and efficiently.”

U.S. Pat. No. 6,766,304 entitled “Click based trading with intuitive grid display of market depth” that issued to Kemp et al. teaches “A method and system for reducing the time it takes for a trader to place a trade when electronically trading on an exchange, thus increasing the likelihood that the trader will have orders filled at desirable prices and quantities. The “Mercury” display and trading method of the present invention ensure fast and accurate execution of trades by displaying market depth on a vertical or horizontal plane, which fluctuates logically up or down, left or right across the plane as the market prices fluctuates. This allows the trader to trade quickly and efficiently.”

U.S. Pat. No. 6,408,282 entitled “System and method for conducting securities transactions over a computer network” that issued to Buist teaches “The system and method of the preferred embodiment supports trading of securities over the Internet both on national exchanges and outside the national exchanges. The preferred embodiment supports an improved human interface and a continuous display of real-time stock quotes on the user's computer screen. The ergonomic graphical user interface (GUI) of the preferred embodiment includes several functional benefits in comparison with existing on-line consumer trading systems. In the preferred embodiment, the users are subscribers to a securities trading service offered over the Internet. Preferably, each subscriber to this service is simultaneously connected from his own computer to a first system which provides user-to-user trading capabilities and to a second system which is a broker/dealer system of his/her choice. The system providing the user-to-user trading services preferably includes a root server and a hierarchical network of replicated servers supporting replicated databases. The user-to-user system provides real-time continuously updated stock information and facilitates user-to-user trades that have been approved by the broker/dealer systems with which it interacts. Users of the preferred system can trade securities with other users of the system. As part of this user-to-user trading, a user can accept a buy or sell offer at the terms offered or he can initiate a counteroffer and negotiate a trade.”

U.S. Pat. No. 5,297,031 entitled “Method and apparatus for order management by market brokers” that issued to Gutterman et al. teaches “There is provided a broker workstation for managing orders in a market for trading commodities, securities, securities options, futures contracts and futures options and other items including: a device for selectively displaying order information; a computer for receiving the orders and for controlling the displaying device; and a device for entering the orders into the computer; wherein the displaying device comprises a device for displaying selected order information about each incoming order, a device for displaying a representation of an order deck and a device for displaying a total of market orders. In another aspect of the invention, there is provided in a workstation having a computer, a device for entering order information into the computer and a device for displaying the order information entered, a method for managing orders in a market for trading commodities, securities, securities options, futures contracts and futures options and the like comprising the steps of: selectively displaying order information incoming to the workstation; accepting or rejecting orders corresponding to the incoming order information displayed; displaying accepted order information in a representation of a broker deck; and selectively displaying a total of orders at the market price.”

Thus, it is desirable to solve some of the problems associated providing risk controls for electronic trading systems allowing trading of synthetic trading entities.

### SUMMARY OF THE INVENTION

In accordance with preferred embodiments of the present invention, some of the problems associated with providing trading strategies for electronic trading systems are overcome. A method and system for providing automatic execution of risk-controlled synthetic trading entities.

Risk parameters are generated for two or more real trading entities that comprise a synthetic trading entity. Risk assessments are generated for the resulting synthetic trading entity from the risk parameters. Current and historical trading information is used to generate the risk parameters and risk assessments. Market prices for the real trading entities to keep the automatic risk-controlled synthetic trading entity at a desired synthetic market price level whenever selected risk assessments exceed one or more pre-determined risk thresholds

The foregoing and other features and advantages of preferred embodiments of the present invention is more readily apparent from the following detailed description. The detailed description proceeds with references to the accompanying drawings.

### BRIEF DESCRIPTION OF THE DRAWINGS

Preferred embodiments of the present invention are described with reference to the following drawings, wherein:

FIG. 1 is a block diagram illustrating an exemplary electronic trading system;

FIG. 2 is a block diagram illustrating an exemplary electronic trading display system;

FIG. 3 is a flow diagram illustrating a method for displaying electronic information for electronic trading;

FIG. 4 is a block diagram of a screen shot of a graphical window produced by application that allows a trader to enter a trading strategy;

FIG. 5 is a block diagram of a screen shot of a graphical window produced by application that allows a trader to enter a trading strategy;

FIG. 6 is a block diagram of a screen shot of a graphical window produced by application that allows a trader to enter a trading strategy;

FIG. 7 is a block diagram of a screen shot of a graphical window produced by application that allows a trader to enter a trading strategy;

FIG. 8 is a flow diagram illustrating a method for automatically executing a synthetic trading entity;

FIG. 9 is a block diagram of a screen shot of an exemplary ABV window;

FIG. 10 is a block diagram of screen shot of an exemplary order ticket window;

FIG. 11 is a block diagram of a screen shot of an exemplary synthetic entity input window;

FIG. 12 is a flow diagram illustrating a method for automatically viewing a synthetic trading entity;

FIGS. 13A and 13B are a flow diagram illustrating a method for automatically executing risk-controlled synthetic trading entities; and

FIG. 14 is a block diagram of a screen shot of three exemplary ABV windows with an alternative display of risk percentages for one or more real trades and a risk percentage for a trading synthetic trading entity comprising the two or more real trading entities being traded for the synthetic trading entity.

### DETAILED DESCRIPTION OF THE INVENTION

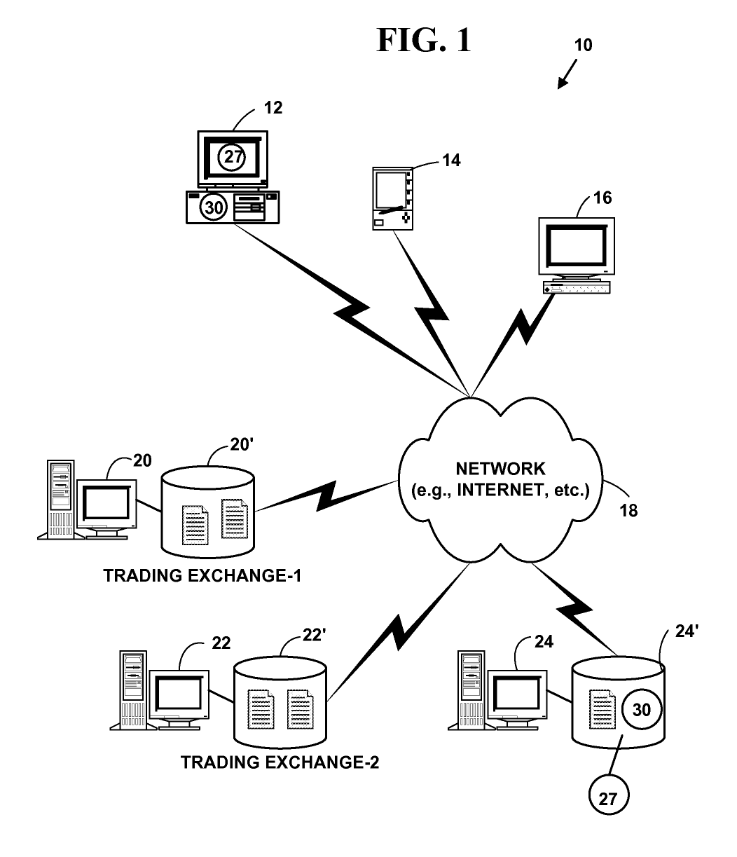

FIG. 1 is a block diagram illustrating an exemplary electronic trading system 10. The exemplary electronic information updating system 10 includes, but is not limited to, one or more target devices 12, 14, 16 (only three of which are illustrated). However, the present invention is not limited to these target electronic devices and more, fewer or others types of target electronic devices can also be used.

The target devices 12, 14, 16 are in communications with a communications network 18. The communications includes, but is not limited to, communications over a wire connected to the target network devices, wireless communications, and other types of communications using one or more communications and/or networking protocols.

Plural server devices 20, 22, 24 (only three of which are illustrated) include one or more associated databases 20′, 22′, 24′. The plural network devices 20, 22, 24 are in communications with the one or more target devices 12, 14, 16 via the communications network 18. The plural server devices 20, 22, 24, include, but are not limited to, World Wide Web servers, Internet servers, file servers, other types of electronic information servers, and other types of server network devices (e.g., edge servers, firewalls, routers, gateways, etc.).

The plural server devices 20, 22, 24 include, but are not limited to, servers used for electronic trading exchanges, servers for electronic trading brokers, servers for electronic trading information providers, etc.

The one or more target devices 12, 14, 16 may be replaced with other types of devices including, but not limited to, client terminals in communications with one or more servers, or with personal digital/data assistants (PDA), laptop computers, mobile computers, Internet appliances, two-way pagers, mobile phones, or other similar desktop, mobile or hand-held electronic devices. Other or equivalent devices can also be used to practice the invention.

The communications network 18 includes, but is not limited to, the Internet, an intranet, a wired Local Area Network (LAN), a wireless LAN (WiLAN), a Wide Area Network (WAN), a Metropolitan Area Network (MAN), a Public Switched Telephone Network (PSTN) and other types of communications networks 18.

The communications network 18 may include one or more gateways, routers, bridges, switches. As is known in the art, a gateway connects computer networks using different network protocols and/or operating at different transmission capacities. A router receives transmitted messages and forwards them to their correct destinations over the most efficient available route. A bridge is a device that connects networks using the same communications protocols so that information can be passed from one network device to another. A switch is a device that filters and forwards packets between network segments. Switches typically operate at the data link layer and sometimes the network layer and therefore support virtually any packet protocol.

The communications network 18 may include one or more servers and one or more web-sites accessible by users to send and receive information useable by the one or more computers 12. The one or more servers, may also include one or more associated databases for storing electronic information.

The communications network 18 includes, but is not limited to, data networks using the Transmission Control Protocol (TCP), User Datagram Protocol (UDP), Internet Protocol (IP) and other data protocols.

As is know in the art, TCP provides a connection-oriented, end-to-end reliable protocol designed to fit into a layered hierarchy of protocols which support multi-network applications. TCP provides for reliable inter-process communication between pairs of processes in network devices attached to distinct but interconnected networks.

For more information on TCP see Internet Engineering Task Force (ITEF) Request For Comments (RFC)-793, the contents of which are incorporated herein by reference.

As is known in the art, UDP provides a connectionless mode of communications with datagrams in an interconnected set of computer networks. UDP provides a transaction oriented datagram protocol, where delivery and duplicate packet protection are not guaranteed. For more information on UDP see IETF RFC-768, the contents of which incorporated herein by reference.

As is known in the art, IP is an addressing protocol designed to route traffic within a network or between networks. IP is described in IETF Request For Comments (RFC)-791, the contents of which are incorporated herein by reference. However, more fewer or other protocols can also be used on the communications network 18 and the present invention is not limited to TCP/UDP/IP.

### Exemplary Electronic Trading Display System

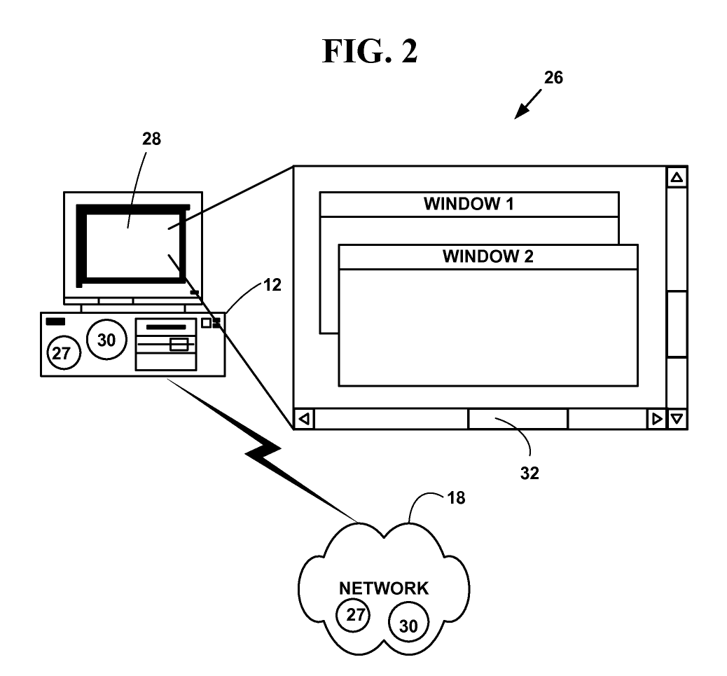

FIG. 2 is a block diagram illustrating an exemplary electronic trading display system 26. The exemplary electronic trading system display system includes, but is not limited to a target device (e.g., 12) with a display 28. The target device includes an application 30 that presents a graphical user interface (GUI) 32 on the display 28. The GUI 32 presents a multi-window interface to a user.

In one embodiment of the invention, the application 30 is a software application. However, the present invention is not limited to this embodiment and the application 30 can use firmware, hardware or a combination thereof.

An operating environment for the devices of the electronic trading system 10 and electronic trading display system 26 include a processing system with one or more high speed Central Processing Unit(s) (“CPU”), processors and one or more memories. In accordance with the practices of persons skilled in the art of computer programming, the present invention is described below with reference to acts and symbolic representations of operations or instructions that are performed by the processing system, unless indicated otherwise. Such acts and operations or instructions are referred to as being “computer-executed,” “CPU-executed,” or “processor-executed.”

It is appreciated that acts and symbolically represented operations or instructions include the manipulation of electrical signals by the CPU or processor. An electrical system represents data bits which cause a resulting transformation or reduction of the electrical signals, and the maintenance of data bits at memory locations in a memory system to thereby reconfigure or otherwise alter the CPU's or processor's operation, as well as other processing of signals. The memory locations where data bits are maintained are physical locations that have particular electrical, magnetic, optical, or organic properties corresponding to the data bits.

The data bits may also be maintained on a computer readable medium including magnetic disks, optical disks, organic memory, and any other volatile (e.g., Random Access Memory (“RAM”)) or non-volatile (e.g., Read-Only Memory (“ROM”), flash memory, etc.) mass storage system readable by the CPU. The computer readable medium includes cooperating or interconnected computer readable medium, which exist exclusively on the processing system or can be distributed among multiple interconnected processing systems that may be local or remote to the processing system.

### Automatically Implementing Trading Strategies for Electronic Trading

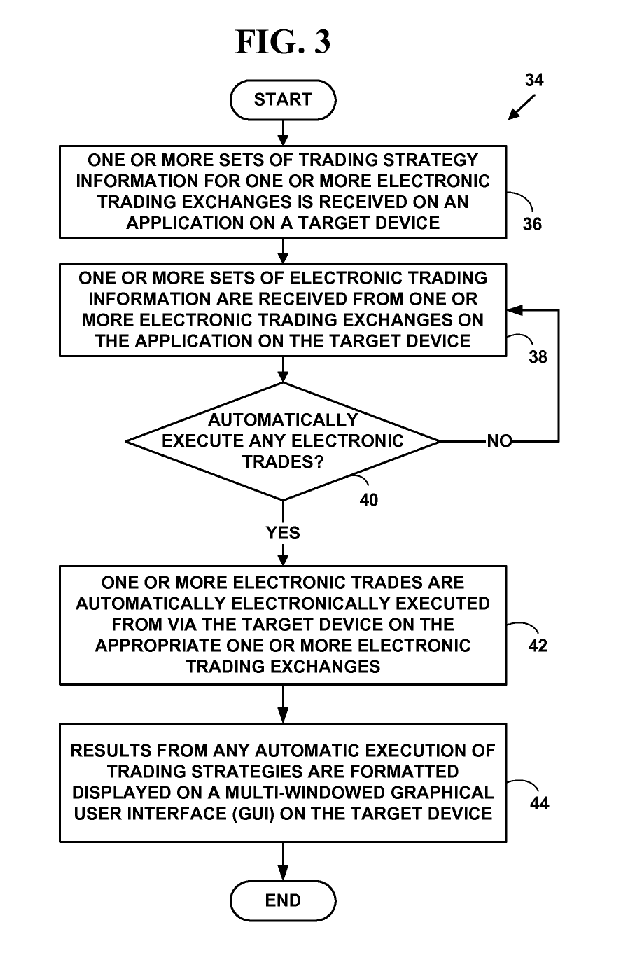

FIG. 3 is a flow diagram illustrating a Method 34 for automatically implementing trading strategies for electronic trading. At Step 36, one or more sets of trading strategy information for one or more electronic trading exchanges are received on an application 30 on a target device 12, 14, 16. At Step 38, one or more sets of electronic trading information are received from one or more electronic trading exchanges on the application 30 on the target device 12, 14, 16. At Step 40, a test is conducted to determine if any of the one or more sets of electronic trading information includes electronic information for automatically executing an electronic trade based on the one more sets of received trading strategy information. If any of the electronic trading information includes any information for automatically executing one or more electronic trades based on the one more sets of receiving trading strategy information, at Step 42, the one or more electronic trades are automatically electronically executed from via the target device 12, 14, 16 on the appropriate electronic trading exchange. At Step 44, Results from any automatic execution of trading strategies are formatted and displayed on a multi-windowed graphical user interface (GUI) 32 on the target device 12, 14, 16.

Method 34 is illustrated with an exemplary embodiment. However, the invention is not limited to this embodiment and other embodiments can also be used to practice the invention.

In such an exemplary embodiment at Step 36, one or more sets of trading strategy information for one or more electronic trading exchanges is received on an application 30 on a target device 12, 14, 16.

The application 30 allows traders to quickly enter in strategy orders in cash and futures contracts and other types of financial instruments that are traded over one or more electronic trading electronic exchanges. The application 30 also allows traders to quickly enter in trading strategies for cash, futures, swap, basis, duration contracts and other types of financial instruments traded via one or more electronic exchanges. The application 30 also provides traders with the ability to input data to automatically initialize ratios, and automatically analyze trading strategies and risk over multiple electronic exchanges. The application 30 allows traders to quickly enter in trading strategies using a minimal number of hand movements (e.g., mouse clicks, keyboard key strokes, etc.).

At Step 40, a test is conducted to determine if any of the one or more sets of electronic trading information includes electronic information for automatically executing an electronic trade based on the one more sets of received trading strategy information. For example, a desired buy or sell number, a desired ratio, a desired basis level, etc.

If any of the electronic trading information includes any information for automatically executing one or more electronic trades based on the one more sets of receiving trading strategy information, at Step 42 the one or more electronic trades are automatically electronically executed from via the target device 12, 14, 16 on the appropriate electronic trading exchange.

In addition to ease of entry, the application 30 provides smart order entry. It does this by passively and actively examining one or more desired electronic trading changes for potential trading executions. This smart order entry provides traders with a unique advantage over traditional order enter systems which do not actively examine market conditions for favorable trading opportunities across multiple markets or multiple electronic trading exchanges.

The application 30 examines multiple electronic trading exchanges for desired trading opportunities based on the received one or more sets of trading strategies. The application 30 also automatically examines cost of carry, execution fees, and market price to automatically determine lowest cost trade. When more than one electronic trading exchange is being consider, the application 30 automatically determines one or more appropriate trades to automatically execute at a comparable price. The application 30 also examines the rate of execution and directs orders to the electronic trading exchange, for example, with the least cost and/or fastest execution rate.

In one embodiment the one or more sets of electronic trading strategy includes a pre-determined trading strategy created by a trader, if-then trading strategies, one-cancels-other (OCO) trading strategies and electronic trading strategies for synthetic instruments or synthetic contracts, or execution of strategies based on previously executed orders.

As is known in the art, the pre-determined strategy trading strategy is a pre-determined trading strategy developed by a trader to apply to a desired market (e.g., cash, futures, stocks, bonds, options, spreads etc.)

As is known in the art, a “synthetic” trading entity includes a synthetic instrument or contract that does not really exist on any electronic trading exchange. A synthetic entity can be made up of one, or several actual contracts that trade on an exchange or multiple exchanges. For example, a synthetic contract may include automatically selling a call and buying a put for two actual futures contracts, an actual futures contract and some other financial instrument, a futures contract and a currency contract, etc. Such a synthetic contract does not exist on any trading exchange but is desirable to a selected group of traders.

As is known in the art, an API is set of routines used by an application program to direct the performance of actions by a target device. In the present invention, the application 30 is interfaced to one or more API.

In another embodiment, the application 30 is directly interfaced to a fixed or dynamic connection to one or more electronic trading exchanges without using an API.

In one exemplary embodiment of the invention, the application 30 interfaces with a Client API provided by Professional Automated Trading Systems (PATS) of London, England, or Trading Technologies, Inc. (TT) of Chicago, Ill. GL Multi-media of Paris, France and others. These APIs are intermediate APIs between the Application and other APIs provided by electronic trading exchanges. However, the present invention is not limited to such an embodiment and other APIs and other fixed or dynamic connections can also be used to practice the invention.

The application 30 presents a user a multi-windowed GUI 32 that implements the functionality exposed through API provided by electronic trading exchanges. The application 30 allows the user to subscribe to and receive real-time market data. Additionally, the application 30 allows the user to enter futures orders, cash orders, and other types of financial products orders to all supported exchanges and receive real-time order status updates. The application 30 supports at least two methods of order entry; Order Ticket and Aggregated Book View (ABV).

The application 30 provides flexibility to the user to configure the display of electronic information on the GUI 32. The application 30 and the GUI are now described in further detail.

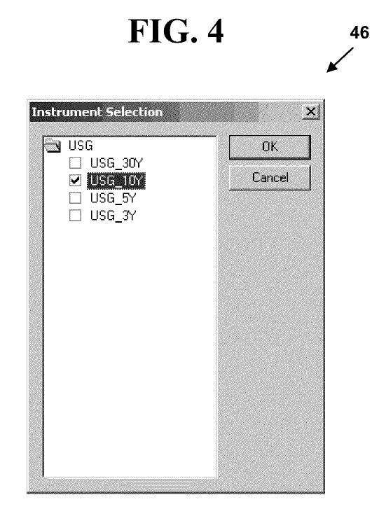

FIG. 4 is a block diagram of a screen shot 46 of a graphical window produced by application 30 that allows a trader to enter a trading strategy. FIG. 4 illustrates a window used to enter a trading strategy to enter a United States Government (USG) ten year treasury note.

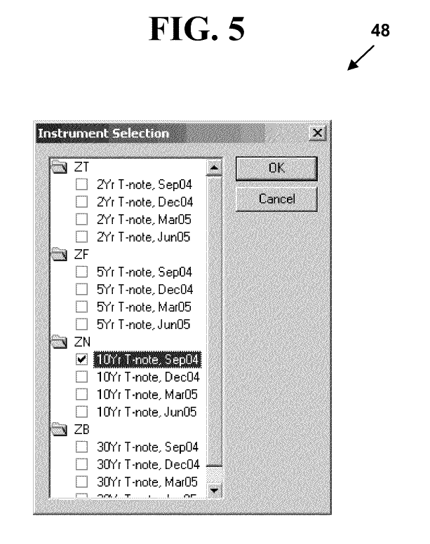

FIG. 5 is a block diagram of a screen shot 48 of a graphical window produced by application 30 that allows a trader to enter a trading strategy. FIG. 5 illustrates a window used to select options for a trading strategy to enter a United States Government (USG) ten year treasury note.

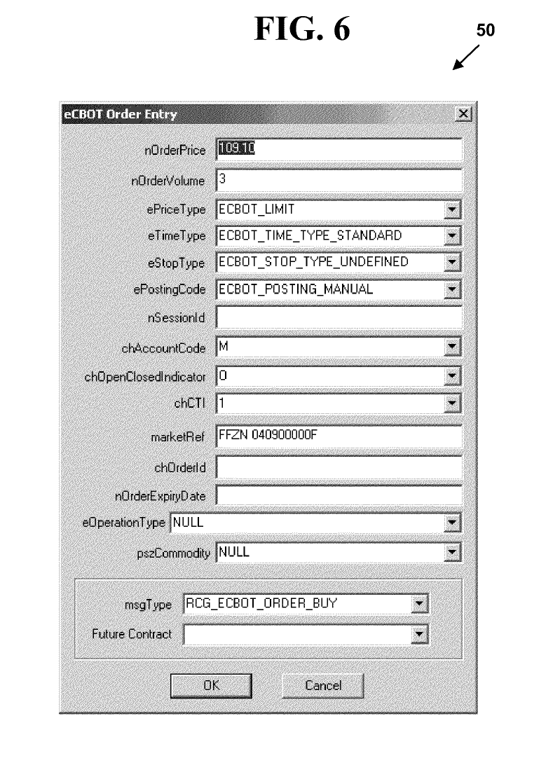

FIG. 6 is a block diagram of a screen shot 50 of a graphical window produced by application 30 that allows a trader to enter a trading strategy. FIG. 6 illustrates a window used to select options for automatically entering an order to buy or sell a financial instrument based on an entered trading strategy.

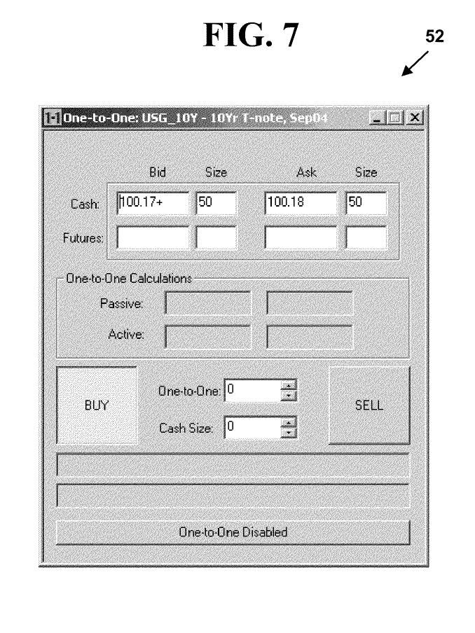

FIG. 7 is a block diagram of a screen shot 52 of a graphical window produced by application 30 that allows a trader to enter a trading strategy. FIG. 7 illustrates a window used to select and display options for a trading strategy.

FIGS. 4-7 represent exemplary screen shot only and only illustrate one entering a trading strategy for one type of financial instrument. However, FIGS. 4-7 are exemplary only and are not meant to limit the scope of the invention.

### Specialized Order Functionality

The application 30 also provides specialized order functionality for actual and synthetic entities. This functionality is available to the user wherever actual or synthetic orders can be entered. The user creates one-cancels-other (OCO) order pairs. An OCO order is one that allows the user to have two working orders in the market at once With the execution of one order the other is canceled. The user can construct an OCO pair across different instruments traded on a single electronic exchange. The user can construct an OCO pair across different instruments on two electronic trading exchanges. The user can construct an OCO pair combining orders of any order type that is supported by the exchange (or supported synthetic order types).

The user cancels OCO orders before exiting the application 30. If the user has any open OCO's upon logoff, the GUI 32 warns the user that the orders will be cancelled and allow the user to cancel the logoff if desired. By default, entering a quantity for the OCO enters that same quantity for both sides of the OCO.

A complete fill of one order cancels the other order. If there is a partial fill on one leg of the OCO, the other side of the OCO is reduced by the amount that was filled. This functionality will only occur if both legs of the OCO are entered with the same quantity. The user has the ability to turn off this functionality, so that the order quantities don't automatically decrement and the orders are canceled only when one order is completely filled. If the user enters different quantities, this functionality are automatically turned off and disabled.

The user can cancel individual orders of the pair, leaving the remaining order in the market. The user can cancel both orders in the pair simultaneously. The user can change the price for an individual order of the pair. The user can create a profit/loss bracket order pair. A Profit/Loss bracket is a specific case of an OCO order pair. This order pair consists of a limit order to establish a profit and a stop loss order to limit loss. The stop loss portion of the bracket should be able to be a “trailing stop.” The use is able to create a profit/loss bracket around an existing position. The user is able to create a profit/loss bracket around a fill. The use can create a profit/loss bracket around an order in the filled state.

The user can create trailing stop orders. A trailing stop is an order that tracks a price of the instrument and adjusts the stop trigger price in accordance with a predefined rule (i.e., stop trigger is changed when the market changes a certain number of ticks).

Trailing stop orders can be either of type stop or stop limit. For stop limit orders, the limit price will be changed such that it keeps the same differential from the stop trigger price. In order to set up the trailing stop rule, the user must enter: the number of ticks that the market must change before the stop trigger price should be adjusted. The number of ticks that the stop trigger price should be adjusted when an adjustment is warranted. A trailing stop order is purely synthetic.

The stop order should only be known to the client until it is actually triggered. At that time either a market order (in the case of an order type of stop) or a limit order (in the case of a stop limit order) will be entered into the market. A trailing stop only adjusts the stop trigger price in the profitable direction of the trade. A trailing stop order to sell does not adjust the stop trigger price to a value less than the initial trigger value. A trailing stop order to sell only increases the stop trigger price. A trailing stop order to sell only adjusts the stop trigger price when new high prices are traded in the instrument. This will prevent adjusting the stop trigger price if the instrument price retraces a profitable move but does not trigger the stop.

A trailing stop order to buy does not adjust the trigger price to a value greater than the initial trigger value. A trailing stop order to buy only decreases the stop price. A trailing stop order to buy must adjusts the trigger price when new low prices are traded in the instrument. This will prevent adjusting the stop trigger price if the instrument price retraces a profitable move but does not trigger the stop. Trailing stops are only valid while the user is logged into the application 30. Application 30 exit will have the effect of the trailing stop not being in the market. On application exit, if the user has trailing stops entered, the user will be warned that the stop will not be worked while the application is closed.

The user is to choose to save trailing stops. On application 30 launch, the user is advised of any saved trailing stops and given the opportunity to reenter them.

The user is able to create parked orders. A parked order is an order that is created by the user but not submitted to the market. The user is able to release a parked order. Releasing a parked order submits it to the market. The user can change a working order to a parked order. This sends a cancel to the exchange. On receipt of the cancel acknowledgement, the application 30 changes the order state to indicate that the order is parked. Parked orders are saved on application exit. Parked orders are restored on application 30 launch.

### If-Then Strategies

The user can create an “If-Then Strategy.” With an If Then Strategy, an order is entered into the market. Upon receipt of a fill acknowledgement for the order, one or more other orders are automatically entered by the application 30 based on the If-Then strategy. Typically, the orders that are entered with If-Then Strategy will be orders to manage profit and loss expectations for the fill that was received on the original order. The user can create an If-Then strategy where on the receipt of the acknowledgement of an order fill, a profit/loss bracket is entered around the fill price for the filled quantity. The user can create an If-Then strategy where on the receipt of the acknowledgement of an order fill, a stop or stop limit order is entered at an offset from the fill price for the quantity of the fill. The user can create an If-Then strategy where on the receipt of the acknowledgement of an order fill, a trailing stop order is entered at an offset from the fill price for the quantity of the fill. The user can create an If-Then strategy where on the receipt of the acknowledgement of an order fill, a limit order is entered at an offset from the fill price for the quantity of the fill. The user can create an If-Then strategy where on the receipt of the acknowledgement of an order fill, an OCO order pair is entered.

### Automatically Executing Synthetic Trading Entities

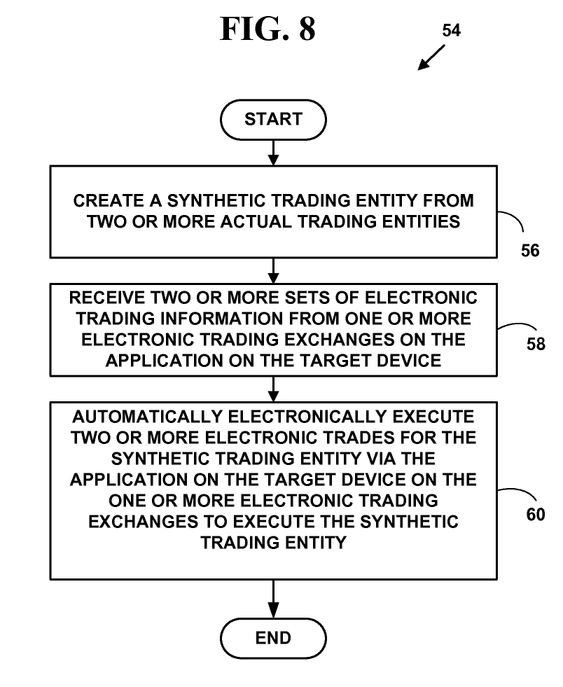

FIG. 8 is a flow diagram illustrating a Method 54 for automatically executing a synthetic trading entity. At Step 56, a synthetic trading entity is created from two or more actual trading entities. At Step 58, two or more sets of electronic trading information are received from one or more electronic trading exchanges on the application 30 on the target device 12, 14, 16 including trading information for the two or more actual trading entities for the created synthetic trading entity. At Step 60, two or more electronic trades for the synthetic trading entity are automatically and electronically executed from via the application 30 on the target device 12, 14, 16 on the one or more electronic trading exchanges to execute the synthetic trading entity.

In one embodiment, Method 54 may further include Step 61 for displaying automatic electronic trading results for the synthetic trading entity via the application 30. In another embodiment, Method 54 may further include displaying automatic electronic trading results for the synthetic trading entity via the application on an Aggregated Book View (ABV) window 66. This window 66 is also called an Ask Bid Volume (ABV) window.

Method 54 is illustrated with an exemplary embodiment. However, the invention is not limited to this embodiment and other embodiments can also be used to practice the invention.

In such an exemplary embodiment, At Step 56, a synthetic trading entity is created from two or more actual trading entities. In one embodiment, the synthetic trading entity includes a synthetic contract. In one embodiment, the synthetic contract includes a synthetic futures contract or a synthetic financial instrument contract, or a synthetic cash instrument contract. In one embodiment, the application 30 includes a multi-windowed application with a graphical user interface (GUI) displaying an Aggregated Book View (ABV) window 66 and/or an Order Ticket window 84 for one or more synthetic trading entities.

In one embodiment, Step 56 includes creating a synthetic trading entity including pre-determined electronic trading strategy created by an electronic strategy, If-Then trading strategies, one-cancels-other (OCO) trading strategies and electronic trading strategies for synthetic instruments or synthetic contracts or trading strategies based on previously executed electronic trades.

In one embodiment, Step 56 includes creating a synthetic trading entity with If-Then electronic trading strategy information that comprises upon receiving of an acknowledgement of an order fill: creating a profit/loss bracket around a fill price for a filled quantity; creating a stop or stop limit order at an offset from a fill price for the quantity of a fill; creating a trailing stop order at an offset from a fill price for a quantity of the fill; creating a limit order at an offset from a fill price for a quantity of the fill; or creating one or more one-cancels-other (OCO) order pairs.

In one embodiment, Step 56 includes creating a synthetic trading entity via a Synthetic Trading Entity window on the application 30. In one embodiment the Synthetic Trading Entity window is available from either the ABV window 66 or the Order Ticket window 84.

At Step 58, one or more sets of electronic trading information are received from one or more electronic trading exchanges on the application 30 on the target device 12, 14, 16 including trading information for the two or more actual trading entities for the created synthetic trading entity. In one embodiment, Step 58 further includes displaying the two or more sets of electronic information individually for the two or more actual trading entities comprising the synthetic trading entity. In another embodiment, Step 58 further includes combining, the two or more sets of electronic information for the synthetic trading entity and displaying electronic trading information for the synthetic trading entity via the application 30. In one embodiment, the synthetic trading entity is displayed by the application 30 on the ABV window 66.

At Step 60, two or more electronic trades for the synthetic trading entity are automatically and electronically executed from via the application 30 on the target device 12, 14, 16 on the one or more electronic trading exchanges to execute the synthetic trading entity.

### Aggregated Book View (ABV) Window

The ABV Window allows the user to view bid size and offer size by price for a particular instrument in a market depth-type format. The window displays working orders for a selected account in a single instrument. The data on this window is displayed and updated in real-time. The window also allows the user to enter various order types. In one embodiment, two ABV windows are displayed by default. In another embodiment, one or more than two ABV windows are displayed by default.

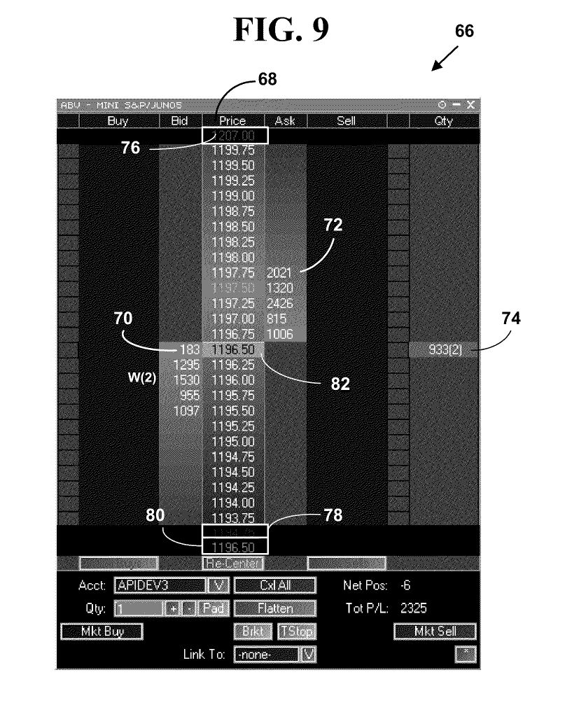

FIG. 9 is a block diagram of screen shot of an exemplary ABV window 66 produced by application 30 displayed on GUI 32. The ABV window 66 includes a dynamically displayed Price column 68.

In one embodiment, the ABV window displays a buy column, a bid column, a dynamic price column, an ask column, a sell column, a quantity column, a re-center button, a cancel buy button, a cancel sell button, a cancel all button, a market buy button, a flatten button, a bracket button, a TStop button, a net position and a total P/L. However, the present invention is not limited to displaying these items and more, fewer or other items can be displayed in the ABV window 66 to practice the invention.

The user can select an instrument or contract to view in an ABV window 66, and can change the instrument or contract from this window 66. Changing the instrument or contract changes the data displayed to that of the selected instrument or contract. The user can select an account from available accounts. The window 66 displays the total quantity of orders working in the market at each price. Both buy and sell quantities are displayed. Quantities are updated as the instrument order book changes. The window 66 displays an indicator depicting the all of the user's open orders, for the selected account, at each price. The window 66 indicates a state of each order. Open order states include, but are not limited to: Queued, Sent, Working, Part Filled, Cancel Pending and Amend Pending, Held, Cancelled, Filled.

This window 66 indicates the order type for each order. The window 66 indicates the working quantity of each order. The window 66 displays parked orders for the selected instrument. The window 66 displays the user's net position in the selected instrument for the selected account. The window 66 displays the trade quantities for each corresponding price level. The user can select to view the total quantity currently trading at a price. This quantity is increased as each trade at a price occurs. The cumulative quantity remains in the window 66 until the price changes (at which time the cumulative trade quantity for the new price will be shown).

The user selects to view the last quantity currently trading at a price. This view shows the individual trade quantities. Only quantities for the current price are shown. The window 66 displays the total traded volume for the instrument. The window 66 displays all of the aforementioned data at once.

The user sets and adjusts the specified quantity for orders entered via this window 66. The quantity is set via a spinner, text entry or keypad entry. Each key-pad input increases a specified quantity by an amount displayed on the key (key value). The user selects to have the specified quantity set to zero after order entry. The user resets the quantity to zero (i.e., without entering an order). A right click on the mouse increases the quantity, left click decreases the quantity.

Orders entered via this window 66 will have a quantity equal to the quantity specified at time of entry. The default account for any orders entered from the ABV window 66 is the selected account. The can enter a limit order by clicking a cell in the bid quantity or offer quantity columns. Limit orders are default order type.

Order side will be set to BUY if the user clicks in the bid quantity column 70. Order side will be set to SELL if the user clicks in the offer quantity column 72. Orders will have a quantity equal to the specified quantity. Order limit price must equal the price corresponding to the clicked offer/bid quantity.

The user enters a stop order by clicking a cell in the bid or offer quantity columns 70, 72. Order side will be set to BUY if the user clicks in the bid quantity column 70. Order side will be set to SELL if the user clicks in the offer quantity column 72. Orders must have a quantity equal to the specified quantity. The order stop price will equal the price corresponding to the clicked offer/bid quantity. The order is entered for the selected account. The user is able to enter a buy stop below the market or a sell stop above the market. If the user does this, a window appears, warning the user that the buy or sell will be immediately executed.

The user can enter an OCO (One Cancels Other) pair of orders. The user can also enter a profit/loss bracket. The user can enter a trailing stop. The user can also enter an “If-Then Strategy.”

The user can change the limit price of a working limit order by dragging the working order indicator to a new price. The user can change the stop price of a working stop order by dragging the working order indicator to a new price. This will cause a cancel replace to be entered at the electronic trading exchange 20, 22. The user can change the quantity of a working order by right clicking in the cell displaying the working order. A right click on a mouse displays a context menu listing order quantities centered on the current quantity. The user can also adjust account number.

The user can cancel a working order with a single mouse click. The user can cancel all open orders in the instrument for the selected account. The can cancel all open buy orders in the instrument for the selected account. The user can cancel all open sell orders in the instrument for the selected account.

Users can have orders at a price displayed as a concatenated total, or displayed as each individual order. When the display of individual orders is to large for the display, individual orders will be displayed starting with the first order entered and then the remaining orders that do not fit in the display will be concatenated. Concatenated orders are indicated as such using a symbol that is attached to the total. Users can also adjust the display of the ABV by adding or removing columns, buttons and functions.

The user uses the open position in the instrument for the selected account. This window 66 includes a Flatten button for flattening the net position. When the user chooses to flatten, all working orders for the instrument are canceled and an order is entered that flattens the net position (i.e., the quantity of the order will be equal to the net position and the order will be placed on the opposite side of the net position). The flattening is achieved with a single order (i.e., the user cannot enter more than one order to flatten).

The user can center the dynamic Price column 68 on the current market. The user can scroll the dynamic Price column 68 to display prices above or below the current market. All data is displayed real-time.

This ABV window 66 follows the standard window rules laid out in the Standard Window. The data in this window is displayed in a grid, but this grid will not follow all of the standard grid rules.

The user can choose from a list of columns to display. Certain columns will be displayed by default. Certain columns will not be removable (price for example). The user can change the order of the displayed columns by dragging a column heading to a new position. The user can manually resize a column. The user can resize all columns to fit the screen. The user can resize all columns to fit the contents. The user can resize a selected column to fit the contents. Double clicking on the column heading border sizes a column so that data only is displayed with no redundant space.

The user can change the font for all columns in the grid. The user can change the font for an individual column. The user can change the foreground color of a column. The user can change the background color of a column. The user can restore the default grid settings.

The ABV window 66 is resizable. When it is resized, the columns expand and contract so that all data is still shown. However, after resizing the window, the user can resize the columns to get rid of wasted space and then change the font size (i.e., so it's more readable when the screen is small).

This ABV window 66 will display the following fields illustrated in Table 1 in a ladder format. However, the present invention is not limited there fields and more, fewer or other types of fields can be used to practice the invention.

TABLE 1
Price

Centered on the current market prices when launched.

Market Bid Quantity
Market Offer Quantity
Trade Quantity as determined in section 11.3 above
Open Buy Orders indicating status, type and quantity for each order
Open Sell Orders indicating status, type and quantity for each order
Parked Orders

The ABV window 66 displays real-time data for a particular contract, allowing a user to get a current snapshot of the market. Thus, the ABV window 66 can also be considered an “Ask, Bid, Volume” window.

An instrument or contract can be added to an open ABV window 66 in the same way that a contract was added to the Quotes window 50. Simply select the contract that to display and then drag it into the ABV window 66. Contracts can be dragged from any of the windows displayed on the screen.

Once a contract has been added to the ABV window, the data illustrated in Table 2 is displayed on the ABV window.

TABLE 2
A current number of Bids 70 and Asks 72 on an electronic trading
exchange 20, 22 for particular price levels.
A total quantity currently trading at a certain price.
A number in parentheses 74 next to the total quantity is the last
quantity traded at that price.
A price in red is the daily high 76. A price shown in blue is the
daily low 78. A last traded price is shown in gray 80.
The last traded price 82 is also highlighted on a dynamic price
column 68. When there has been an uptick in this price, this cell
will be green. When there has been a downtick, this cell will be
red. If there has been no change, this cell will appear yellow.
The Buy and Sell columns display a total number of open orders at
each particular price. For example, a “W2” in the Buy column
indicates that there are working orders with a total quantity of
two at the specified price.
Net Position and Total P/L on the ABV can be monitored by simply
referring to the lower right hand corner of the window.

On the ABV window 66, the price of any open Buy or Sell orders can be amended. To change the price of an order, a row selector that corresponds with the order to amend is selected buy left-clicking and holding down a left mouse button, dragging a cursor connected to the mouse up or down to a desired new price and releasing the mouse button. A white cursor arrow appears to indicate a change in price. The price amended will be submitted as soon as the mouse is released. If there multiple orders at the same price (and on the same side), all of the orders will be amended to the new price when dragging the concatenated order. The user can cancel a signal order at a price where multiple orders exist. They can also modify a single order at a price where multiple orders exist. They do this by selecting the individual order and dragging and dropping.

Another feature of the ABV window 66 is that a desired position on the dynamically displayed Price column 68 can be moved. If it is desired to scroll up or down on a market price on the dynamically displayed Price column 68, the dynamically displayed Price column 66 is hovered over with a mouse. A yellow cursor arrow will appear, pointing up if the mouse cursor is in the top half of the dynamic price column 68, or down, if the mouse cursor is in the bottom half of the dynamic Price column 68. Clicking on the cursor arrow will scroll the grid in the direction that the arrow points.

The ABV window 66 provides a dynamic Price column 68 centered upon the lasted traded price that continuously changes with fluctuations in the last traded price. To enter an order, a mouse cursor is hovered anywhere in the ABV window 66. This mouse hover puts a user in the “order entry mode.” In the order entry mode a trade near last traded price can be entered or prices on the dynamic price column can be manually adjusted away from the last traded price. To scroll up or down the market prices on the dynamic Price column 68 to enter a trade, the mouse cursor is hovered over the dynamic Price column 68. A large yellow arrow will appear, pointing up if the mouse cursor is in the top half of the dynamic price column, or down, the mouse cursor is in the bottom half of the dynamic price column. Clicking on the large yellow arrow will scroll the prices in the dynamic price column in the direction that the large arrow points so a trade can be entered away from a current market price.

If the dynamic Price column 68 is scrolled up or down and the last traded price is not centered on your ABV, the dynamic price column will start to scroll until the last traded price is again centered in the ABV window 66. In addition, if there is no further activity from a mouse for a period of time the dynamic Price column 68 will also start to scroll. As a visual indication, just before the dynamic price column begins to scroll, the mouse cursor will turn yellow and start to flash. This is a warning that the ABV window is about to begin re-centering around the last traded price. If, at any time, the mouse cursor is moved out of the ABV window, you leave the order entry mode and the ABV will automatically re-center the dynamic price column on the last traded price the next time the market price changes.

Stop and limit orders can also be entered on the ABV window 66 with just a click of a mouse. Before entering limit or stop orders an account is chosen and a quantity is entered. If a user has access to multiple accounts, the user can select the desired account by using the Account drop down menu. The user can input a number of lots to trade by typing the number in, by using the + or − buttons, or by using a keypad. A default quantity can be set via the Settings window. After selecting an account and quantity, limit and stop orders can be placed.

To enter a Buy Limit order, the mouse is clicked in the Bid column next to the Price to enter the order for. A limit order to buy will be entered at that price for the quantity specified, and a new working order will be reflected in the Buy column. Likewise, to enter a Sell Limit order, the mouse is clicked in the Ask column next to the Price to enter the order for.

To enter a Buy Stop order, the mouse is right-clicked in the Bid column next to the Price to enter the order for. A stop order to buy will be entered at that price for the quantity specified, and a new order will be reflected in the Buy column. Similarly, to enter a Sell Stop order, the mouse is right-clicked in the Ask column next to the Price that you want to enter the order for.

In addition to Limit and Stop orders, Market orders can be executed on the ABV window 66 using the Market Buy and Market Sell buttons. The ABV window can also be set up so that a Bracket or Trailing Stop order will automatically be created any time an order entered via the ABV is filled. The Bracket and Trailing Stop parameters will default to the values set up on the Settings window. To link a Bracket or Trailing Stop order to all orders entered via the ABV, choose Bracket or TStop from the Link To drop down box. A small window pops up with the default parameters for a bracket. The bracket levels can be changed by typing in a desired number, or using the “+” and “−” buttons. A limit order will be the profit order type, and for a loss order type, either choose a stop or a trailing stop can be selected.

For example, if a stop order is chosen, as soon as the order was filled, two new orders were entered. A limit order was created at a price that is five ticks above the market order's price and a stop order was created at a price that is three ticks below the market order's price. Both orders have the same quantity that the market order had. Because these orders were entered as part of a bracket, when one of these orders is filled, the other will automatically be cancelled. Likewise, TStop is chosen from the Link To drop down box, a small window will appear that allows you to view and change trailing stop parameters. Like the bracket, a trailing stop will be entered once an order entered via the ABV window 66 is filled.

The ABV also allows cancellation of some or all of working orders as well. To cancel a particular order, the mouse cursor is placed over that order in the Buy or Sell column, whichever applies, and a yellow X appears over the working order. A mouse click on the yellow X will cancel that particular order. If multiple orders are entered at the same price (and on the same side), they will all be cancelled.

### Order Ticket Window

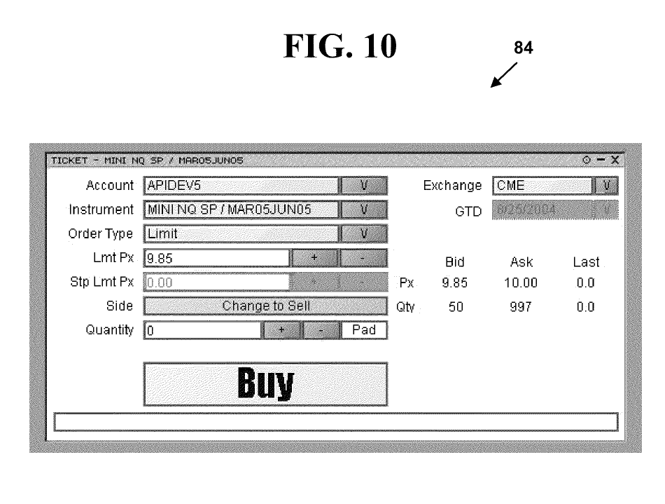

FIG. 10 is a block diagram of screen shot of an exemplary Order Ticket window 84 produced by application 30 and displayed on GUI 32. This window 84 allows the user to create and enter all types of orders supported by the application and the APIs used. Multiple order tickets can be launched and multiple Order Ticket windows 84 will be created. Order types, including Synthetic order types can be entered from this window. If necessary, the Order Ticket window will change or launch supporting dialogs to accommodate complex actual or synthetic order types.

The user can select the account that the order applies to. The user can change the side of the order. The ticket background color depends upon the side chosen. For example, the background is set to blue for buy orders and set to red for sell orders. The following market data is displayed, but is not limited to, on this window 84 for the selected instrument: bid price, bid size, ask price, ask size, and last traded price.

The window 84 can also be resized. The user can select to have the order ticket always on top. This window 84 is comprised of all the fields necessary to enter an order for an actual or synthetic entity.

Table 3 illustrate a list of the fields that are use to create a standard order. Synthetic orders also created directly from this window 84. In another embodiment, a separate window may be launched, or there may be some other method of accessing synthetic order entry. However, the present invention is not limited to this order information and more, fewer or other types of order information can be used to practice the invention.

TABLE 3
Exchange

The default value for this field is determined from the window
where it was launched or in Settings.

Instrument

This field is filtered to display valid instruments based on the
exchange that is selected.

Contract Date

This field is filtered to display valid contract dates based on
the instrument that is selected.

Order Type

This field is filtered to display valid order types based on the
exchange that is selected.

Limit Price

This field defaults to either the current bid, ask or last as
determined by Settings and by the side.
This price does not change once the order is open.
This field is enabled only for stop, stop limit, MIT orders and
the synthetic equivalents for those order types.
The use is able to enter the price via keyboard entry or spinner,

Order Quantity

The user is able to change the specified order quantity through
a key-pad control.
Each key-pad input increases the specified quantity by the amount
displayed on the key (the key value).
The user has ability to set the quantity back to zero.
The user is able to select to have the specified quantity set to
zero after order entry.

Secondary Price

This field is enabled only for stop limit orders.

Good-Till-Date

This field is enabled only for orders with TIF (Time in Force) of
GTD.
This field defaults to the current trade date.

### Synthetic Entity Input Window

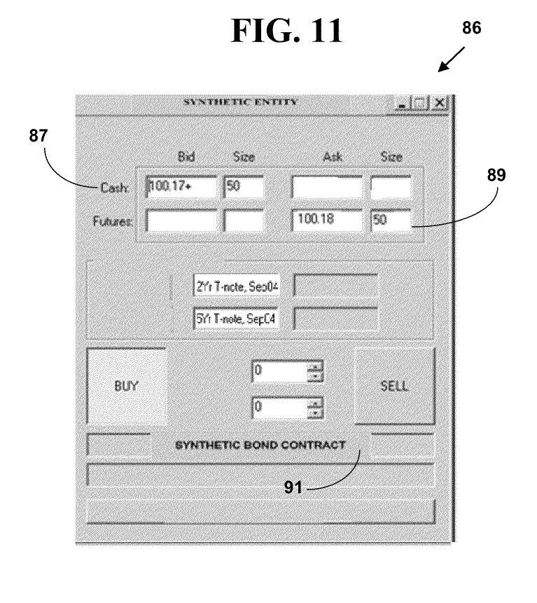

FIG. 11 is a block diagram of a screen shot of an exemplary synthetic entity input window 86. This exemplary synthetic entity input window 86 includes a window for creating a synthetic entity with two or more actual futures and cash contracts. However, the present invention is not limited to this exemplary synthetic entity input window 83 and other synthetic entity input windows with more fewer or other information can also be used to practice the invention.

### Automatically Displaying Synthetic Trading Entities

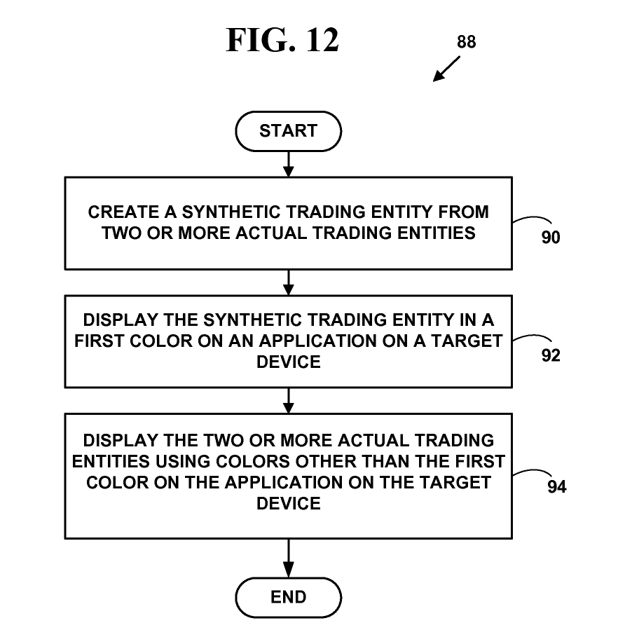

FIG. 12 is a flow diagram illustrating a Method 88 for automatically displaying a synthetic trading entity. At Step 90, a synthetic trading entity is created from two or more actual trading entities. At Step 92, the created synthetic trading entity is displayed with a first color via an application 30 on a target device 12, 14, 16. At Step 94, two or more actual trading entities are displayed in colors other than the first color via the application 30 on the target device 12, 14, 16.

Method 88 is illustrated with an exemplary embodiment. However, the invention is not limited to this embodiment and other embodiments can also be used to practice the invention.

In such an exemplary embodiment At Step 90, a synthetic trading entity is created from two or more actual trading entities as was described above for Method 54.

At Step 92, the created synthetic trading entity is displayed with a first color the application 30 on the target device 12, 14, 16. For example, created synthetic trading entities may be displayed with a purple color to distinguish the synthetic trading entity for the actual trading entities. However, the present invention is not limited to such an embodiment and other embodiment can also be used to practice the invention.

In one embodiment, the synthetic trading entity is displayed via the application 30 via the ABV window 66 or the Order Ticket Window 84 with the first color. In one embodiment, Step 92 further includes: receiving a selection input for the created synthetic trading entity and displaying the two or more actual trading entities used to create the synthetic trading entity via the application 30 on the target device 12, 14, 16.

At Step 94, two or more actual trading entities are displayed in colors other than the first color via the application 30 on the target device 12, 14, 16.

It is desirable to provide trading of synthetic trading entities with risk management, assessment and control. Such risk management assessment and controls are preferably executed automatically via application 30 on the target devices 12, 14, 16.

### Trading Risk-Controlled Synthetic Trading Entities

“Risk management” is the discipline of identifying, monitoring and limiting risks. Risk management methodologies typically consist of a number of analysis steps, including but not limited to, identifying critical assets, identifying, characterizing, and assessing threats to the identified assets, assessing the vulnerability of critical assets, identifying ways to reduce vulnerability of critical assets, creating a risk management strategy and prioritizing risk reduction measures.

The risk management strategies include, but are not limited to, transferring the risk to another party, avoiding the risk, reducing the negative effect of the risk, and accepting some or all of the consequences of an existing risk. In ideal risk management, a prioritization process is followed whereby the risks with the greatest loss and the greatest probability of occurring are handled first, and risks with lower probability of occurrence and lower loss are handled in descending order.

Once risks have been identified and assessed, techniques to manage the risk typically fall into one or more major categories including, but not limited to, risk avoidance, risk reduction, risk transfer and/or risk retention.

Risk management is used for electronic trading to identify and mitigate risks associated with electronic trading. Risk management is analyzed at plural levels, including but not limited to, a trader, broker, trading firm, fund manager, trading exchange level, etc.

For example, trading of commodities futures contracts is a zero sum transaction wherein there is a winner and a loser for every trade and trades are reconciled daily. An electronic trader typically opens a trading account (also called a “margin account”) with a certain minimum amount of trading capital with one or more brokers who provide the ability for the electronic trader to execute electronic trades on one or more trading exchanges.

A “margin” is collateral that the holder of a trading position (e.g., electronic trader, etc.) in securities, options, or futures contracts has to deposit to cover the credit risk of his/her broker. This risk can arise if the electronic trader has borrowed cash from the broker to buy securities or options, sold securities or options short, or entered into a futures contract, etc. Risk management typically includes evaluating not only electronic trading activities, but also margin values for one or more margin accounts held by the electronic trader.

If an electronic trader is trading a commodity contract, and has bought the contract expecting the price of the commodity to rise, the trader may lose money if the price of the commodity declines. Theoretically, the trader's risk of loss is limited only by the price of the commodity going to zero, the point at which the trader has lost all of his/her money.

If a trader sells a commodity contract short expecting the price of the commodity to decline, the trader will lose money if the price of the commodity goes up. The risk of loss is theoretically unlimited because there is no absolute ceiling on how high the price of the commodity can go.

Risk management is important not only for an electronic trader, but for brokers, trading firms, fund managers, trading exchanges and other entities involved in electronic trading and other types of electronic and non-electronic (e.g., open outcry, etc.) trading.

A “commodity broker” is a firm or individual who executes orders to buy or sell commodity contracts on behalf of clients and charges them a commission. A firm or individual who trades for his/her own account electronically via a commodity broker (or other broker) is called an “electronic trader.” Commodity contracts include futures, options, and similar financial derivatives. Clients who trade commodity contracts are either hedgers using the derivatives markets to manage risk, or speculators who are willing to assume that risk from hedgers in hopes of a profit.

Other types of brokers include Futures Commission Merchants (FCMs), Independent Introducing Brokers (IIBs), Guaranteed Introducing Brokers (GIBs), Foreign Introducing Brokers (FIBs), Commodity Trading Advisors (CTAs), Commodity Pool Operators (CPOs) Broker-Dealers (B/Ds) and other types of brokers.

The present invention presents a solution to manage risk for electronic trading and for non-electronic trading. One of the benefits of this solution is the ability to capture information about a trade independent of the source of execution of the trade. The trade execution could be electronic execution by the electronic trader, a broker executed trade, an open outcry trading floor based trade or a walk-in trade.

The present invention also provides risk management by looking at a trader via an “integrated viewpoint.” The present invention is unique and provides unexpected results because the present invention aggregates a trader's activities across all their trading accounts, their current and historical trades and trade locations on all trading exchanges (e.g., Chicago Board of Trade (CBOT), New York Stock Exchange (NYSE), NASDAQ, Tokyo Stock Exchange (TSE), London International Financial and Futures Options Exchange (LIFFE), etc.) and values of all their margin capital accounts.

### Managing Risk for Trading Synthetic Trading Entities

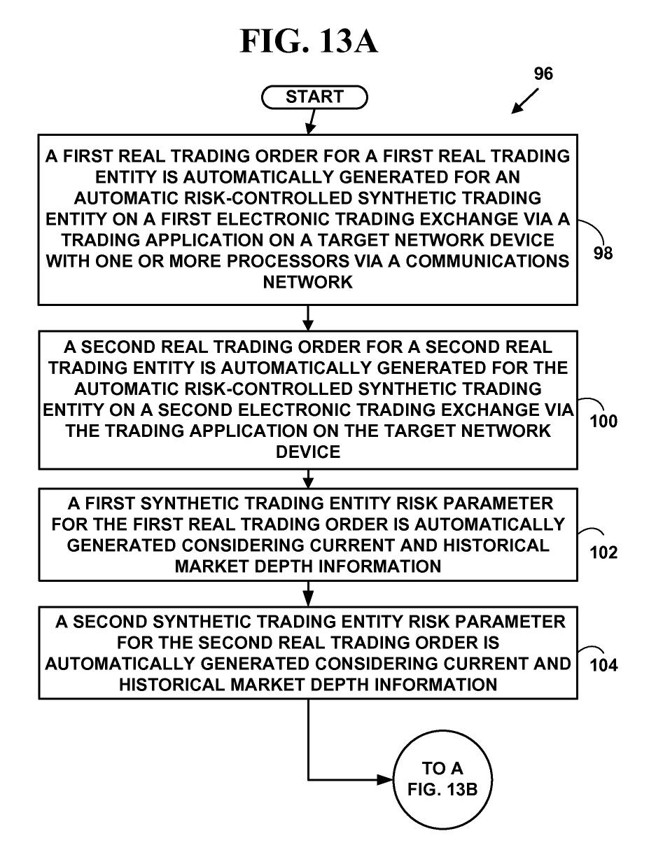

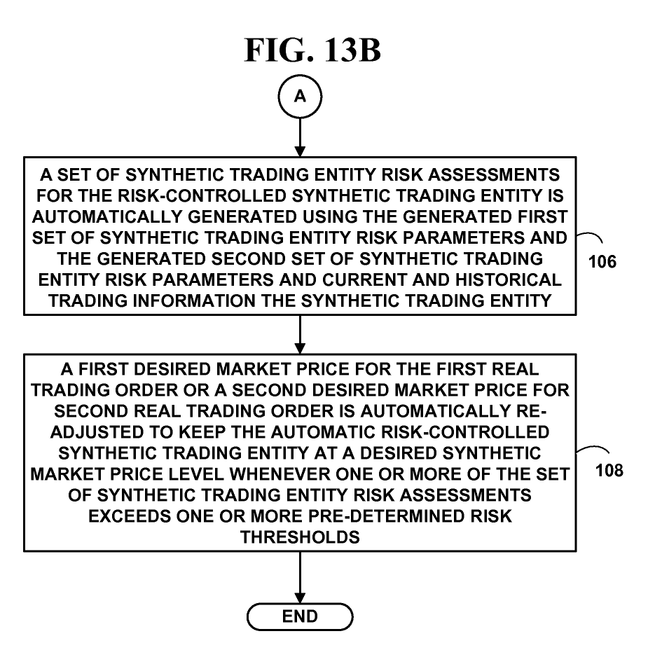

FIGS. 13A and 13B are a flow diagram illustrating a Method 96 for are a flow diagram illustrating a method for automatically executing risk-controlled synthetic trading entities. In FIG. 13 at Step 98, a first real trading order for a first real trading entity is automatically generated for an automatic risk-controlled synthetic trading entity on a first electronic trading exchange via a trading application on a target network device with one or more processors via a communications network. The synthetic trading entity includes two or more real trading entities. At Step 100, a second trading order for a second real trading entity of the automatic risk-controlled synthetic trading entity is automatically on a second electronic trading exchange via the trading application on the target network device. At Step 102, a first set of synthetic trading entity risk parameters for the first real trading order is automatically generated considering current and historical market depth information for the first real trading entity. At Step 104, a second set of synthetic trading entity risk parameters for the second real trading order is automatically generated considering current and historical market depth information for the second real trading entity. In FIG. 13B at Step 106, a set of synthetic trading entity risk assessments for the risk-controlled synthetic trading entity is automatically generated using the generated first set of synthetic trading entity risk parameters and the generated second set of synthetic trading entity risk parameters and current and historical trading information the synthetic trading entity. At Step 108, a first desired market price for the first real trading order or a second desired market price for the second real trading order is automatically re-adjusted to keep the automatic risk-controlled synthetic trading entity at a desired synthetic market price level whenever one or more of the set of synthetic trading entity risk assessments exceeds one or more pre-determined risk thresholds.

Method 96 is illustrated with one exemplary embodiment. However, the present invention is not limited to this embodiment and other embodiments can also be used to practice the invention.

In such an exemplary embodiment in FIG. 13 at Step 98, a first real trading order 87 (FIG. 11) for a first real trading entity is automatically generated for an automatic risk-controlled synthetic trading entity 91 on a first electronic trading exchange 20, 22 via a trading application 30 on a target network device 12, 14, 16 with one or more processors via a communications network. The synthetic trading entity 91 includes two or more real trading entities 87, 89 (FIG. 11).

At Step 100, a second trading order 89 for a second real trading entity of the automatic risk-controlled synthetic trading entity 91 is automatically on a second electronic trading exchange 20, 22 via the trading application 30 on the target network device 12, 14, 16. In one embodiment, the first electronic trading exchange and the second electronic trading exchanges are a same electronic trading exchange (e.g., 20, etc.). In another embodiment, the first electronic trading exchange and the second electronic trading exchange are different electronic trading exchanges (e.g., 20 and 22, etc.).

At Step 102, a first set of synthetic trading entity risk parameters for the first real trading order 87 is automatically generated considering current and historical market depth information for the first real trading entity.

At Step 104, a second set of synthetic trading entity risk parameters for the first real trading order 89 is automatically generated considering current and historical market depth information for the second real trading entity.

In one embodiment, electronic trading information for an electronic trader trading an synthetic trading entity 91 is automatically and periodically collected in real-time via a communications network 18 via a risk application 27 executing in a memory on a server network device 24. In another embodiment, the risk application 27 is executing on the target network devices 12, 14, 16. In another embodiment, the risk application 27 is executing on both the server network device 26 and the target network devices 12, 14, 16. In one embodiment, risk application is integral to trading application 30. In another embodiment, risk application 27 is a separate application.

The collected electronic trading information includes current and historical electronic trading execution information and current market trading information from plural electronic trading exchanges 20, 22, one or more trading accounts being used by the electronic trader to trade one or more real trades for the synthetic trading entity and historical information about the synthetic trading entity itself. The one or more trading accounts including current trading positions, profits and loss and current available trading capital in the one or more trading accounts including margin accounts.

In one embodiment, the one or more trading accounts including trading accounts at one or more brokers. For example, the electronic trader may have a trading account with one or more brokers such Rosenthal Collins Group, LLC, Cantor Fitzgerald, E-trade, etc. Electronic trading information is automatically, collected for all trading accounts being used by the electronic trader.

In such an embodiment, electronic trading information from plural electronic trading exchanges 20, 22 is received via a communications network 18 on a target device 12, 14, 16.

In one embodiment, the electronic trading information includes original real-time data streams and/or historical data streams from the electronic trading exchanges. The electronic trading information is used to provide real-time notification and display of electronic stock, bond, cash, financials, options and commodity futures trades, real-time calculation of profit and loss (P&L) marked to market, including commissions, real-time calculation of current positions in multi-level markets. This information is provided for more real and synthetic trades trading spreads and yield curves. In one embodiment, the processed electronic trading information is used in part for risk assessment of one or more real trades executed automatically for risk-controlled synthetic trading entity.

The electronic trading information is processed with a pre-determined method to create a set of risk parameters for real trading entities and/or trading synthetic trading entities. The set of risk parameters for trading synthetic trading entities including current risk parameters and historical risk parameters and provide an integrated view of current and historical trading activities and trading resources of the electronic trader across all electronic trading exchanges the electronic trader is trading on (e.g., Chicago Board of Trade (CBOT), New York Stock Exchange (NYSE), NASDAQ, Tokyo Stock Exchange (TSE), London International Financial and Futures Options Exchange (LIFFE), etc.).

The electronic trading information is processed with a pre-determined method to create a set of risk parameters for trading synthetic trading entities. The set of risk parameters include current risk parameters and historical risk parameters and provide an integrated view of current and historical trading activities and trading resources of the electronic trader for trading real trading entities and synthetic trading entities.

In one embodiment, the set of risk parameters include, but are not limited to, maximum absolute position value by all accounts on all trading exchanges, absolute net position change by all accounts on all trading exchanges, total change in all positions in all accounts in all trading exchanges, total account value decline of greater than a pre-determined threshold (e.g., greater than 20%, etc.), total trade volume and net profit and loss or each real trading order 87, 89 of a real trading entity being traded for an automatic risk-controlled synthetic trading entity 91 and for the automatic risk controlled synthetic trading entity 91 itself.

In one embodiment, the pre-determined method, includes, but is not limited to, producing real-time statistical studies of the collected electronic trading information including real-time statistical studies of historical electronic trading information and real-time statistical studies of current electronic trading information.

In FIG. 13 at Step 106 a set of synthetic trading entity risk assessments for the risk-controlled synthetic trading entity is automatically generated using the generated first set of synthetic trading entity risk parameters and the generated second set of synthetic trading entity risk parameters and current and historical trading information the synthetic trading entity. If the synthetic trading entity 91 is being traded for a first time and has never been traded before, no historical trading information will be available for it.

Plural different risk synthetic trading entity risk assessments are determined from first and generated set of risk parameters for the real trading entities and current and historical trading information for the synthetic trading entity. The plural risk assessments include, but is not limited to, total account values, prior historical trading histories, current trading histories, etc. across all accounts with all brokers, etc. on all trading exchanges for each real trade being traded for an automatic risk-controlled synthetic trading entity and for the automatic risk controlled synthetic trading entity itself. The plural different synthetic trading entity risk assessments include one or more risk thresholds determined automatically and dynamically from the created set of risk parameters.

In one embodiment, the synthetic trading entity risk assessments are automatically and dynamically determined based on dynamic or static risk management trading value amounts currently being used for a pre-determined hierarchy. In one embodiment, the pre-determined hierarchy is an account hierarchy that includes: (1) trading firm; (2) trading firm office (e.g., a trading firm may have plural offices at plural geographic locations, etc.); and (3) trading account. In another embodiment, the pre-determined hierarchy includes: (1) current trading positions; (2) historical trading activity; (3) trading account margins. However, the present invention is not limited to such an embodiment and other hierarchies with more, fewer or different components can also be used to practice the invention.

In one embodiment, for historical assessments, the synthetic entity risk assessment is based on a model of all of the electronic trader's accounts historical behavior. In one embodiment, the historical risk thresholds are calculated dynamically and automatically in real-time using statistical modeling in part using the formula illustrated in Equation (1) for real trades automatically executed for the risk-controlled synthetic trading entity. However, the present invention is not limited to this formula and other formulas can be used to practice the invention.

Maximum of ((X*average account daily trade volume)+(Y*(standard deviation of account daily trade volume)) or Base Value, (1)

where X and Y are trading values determined for the electronic trader.

Historical trading information is used for evaluating risk for an electronic trader as in certain instances, based on current economic conditions, current market conditions, current margin amounts, an electronic trader may execute a trade with a larger or extreme amount of risk not only to the trader, but to the broker, trading firm, etc. In addition, a trader who has been making certain kinds of electronic trades with certain defined sets of trading parameters, may all of a sudden start making different kinds and amounts of electronic trades, thereby increasing the risk to the trader, broker, trading firm, etc. In such a circumstance, the broker, trading firm, etc. may be alerted in real-time and require the electronic trader take some additional steps to continue trading (e.g., add more money to margin accounts, remove other trading positions, etc.).

At Step 108, a first desired market price for the first real trading order 87 or a second desired market price for the second real trading order 89 is automatically re-adjusted to keep the automatic risk-controlled synthetic trading entity 91 at a desired synthetic market price level whenever one or more of the set of synthetic trading entity risk assessments exceeds one or more pre-determined risk thresholds.

In one embodiment, the pre-determined risk thresholds include market depth risk threshold for the first real trading order or the second real trading order.

In another embodiment, the pre-determined risk thresholds include a synthetic trade risk threshold dynamically and automatically calculated in real-time using statistical modeling for current and historical trading of the synthetic trading entity.

In another embodiment, the pre-determined risk thresholds include the risk thresholds described above.

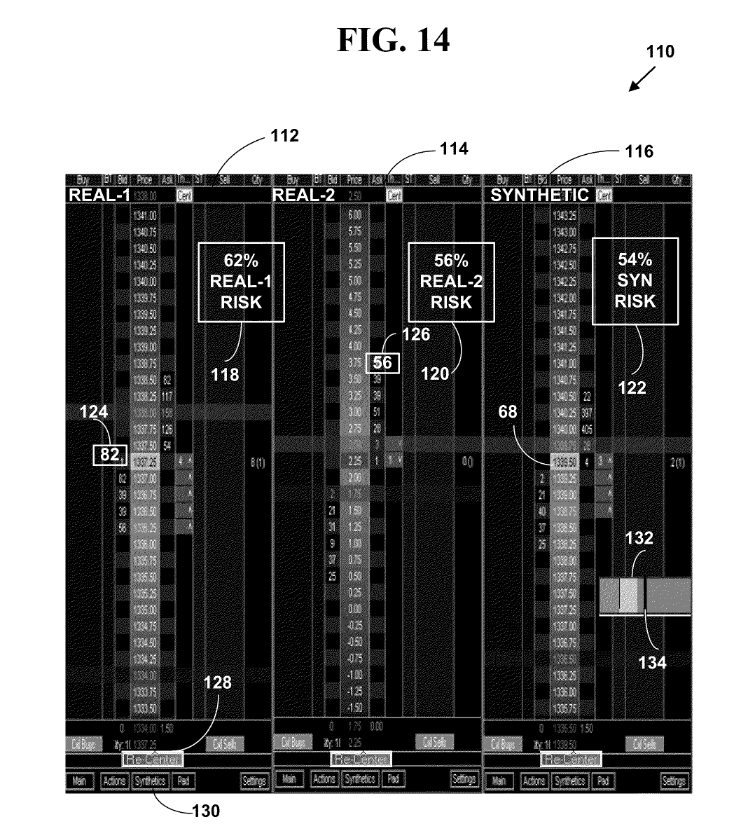

FIG. 14 is a block diagram 110 of a screen shot of three exemplary ABV windows 112, 114, 116 with an alternative display of risk percentages for one or more real trades 118, 120 and a risk percentage for the trading synthetic trading entity 122 comprising the two or more real trading entities being traded for the synthetic trading entity 122.

In one embodiment, the risk percentages displayed 118, 120 for the real trading entities are calculated from the generated first and second synthetic trading entity risk parameters. The risk percentage for the synthetic trading entity 122 is calculated from the generated set of synthetic trading entity risk assessments. However, the present invention is not limited to such an embodiment and other embodiments can be used to calculate and display the risk percentages. The risk percentages are illustrated as text. However, the present invention is not limited to this embodiment and other embodiments can also be used to practice the invention, including graphical graphs, thermometers, meters, etc. displaying a plurality of different colors for a plurality of different risk levels (e.g., green, yellow red, for low, medium and high risk, etc.).

For example, FIG. 14 illustrates a graphical meter 132 graphically displaying the risk level for the synthetic trading entity in a graphical format with three colors of green, yellow and red. The meter line 134 graphically indicates the risk percentage of 54% displayed in text box 122 and indicates visually the risk for trading the synthetic trading entity is in a low risk category indicated by a green color. The colors displayed in this graphical meter 132 from left to right are red, yellow then green.

In one embodiment, both text and graphical risk displays 118, 120, 122, 132 are included on the ABV windows 66. In another embodiment either text or graphical risk displays are included on the ABV window 66.

When trading real trading entities for synthetic trading entity in a given market is particularly wide it can be very difficult to obtain an overall visual view a spread market when dynamic centering on a last traded price is used and displayed in an ABV window 66. This is particularly apparent during market pre-opens when a last traded price for one real trading order may be quite far off of where the best bid/offer are displayed for trading the synthetic trading entity. In order to overcome this situation, an ABV window 66 used to display one or more real trading orders for the synthetic trading order, the ABV window 66 is dynamically and automatically centered on either last traded, best bid, or best offer in each ABV window 66.

In one embodiment, an exemplary ABV window 66 further includes a dynamic bid column 124, a dynamic ask column 126 in addition to the dynamic price column 68. The exemplary ABV window 66 also includes a manual re-center button 128 to manually re-center the dynamic price column 68, the dynamic bid column 124 and/or dynamic ask column 126.

These columns and dynamically and automatically and continuously re-centered with the need for any manual input. However, all of these columns can be manually scrolled away from a current last traded price, lasted traded bid or last traded asked. When manually scrolled away, the columns are automatically and dynamically re-centered. However, there may instances in which an electronic made may desire to immediately re-center a column to re-set a view in and ABV window 66. That is when the manual re-center button 128 is used. However, manual re-centering is never required as all columns will be dynamically, automatically and continuously re-centered.

The dynamic price column 68 is automatically, dynamically and continuously re-centered upon the lasted traded price. The dynamically, automatically and continuously re-centering changes with fluctuations in a last traded price.

The dynamic bid column 124 is automatically, dynamically and continuously re-centered upon the lasted traded or best bid. The dynamically, automatically and continuously re-centering changes with fluctuations in a last traded bid.

The dynamic ask column 126 is automatically, dynamically and continuously re-centered upon the lasted traded or best ask. The dynamically, automatically and continuously re-centering changes with fluctuations in a last traded ask

In one embodiment, a dynamic price column 68 is selectable and configurable by a trader via the Tools window 46, the ABV window 66 and/or other graphical windows 64, 84, 86, 104 etc.

In one embodiment, the manual re-center button 128 accepts a single selection input to manually re-center the dynamic price column 68 on the last traded price, the dynamic bid column 124 on the last traded or best bid, or on the last traded ask column 126 on the last traded or best ask.

In another embodiment, the manual re-center 128 button accepts plural selection inputs to manually re-center the dynamic price column 68 on the last traded price, the dynamic bid column 124 on the last traded or best bid, or on the last traded ask column 124 on the last traded or best ask. In such an embodiment, each selection input received selects a different dynamic column.

In one embodiment, each individual ABV window 66 window can include a selection of a same dynamic price 68, ask or bid column 124, 126, or a combination therein of different dynamic price, ask or bid columns 68, 124, 126.

For example, in FIG. 14, the first ABV windows may include a dynamic price column 68, the second ABV window may include a dynamic bid column 124 and the third ABV window may include a dynamic ask column 126, etc.

The ability to select among dynamic price 68, bid and ask columns 124, 126, also help lower plural different risks associated with trading risk-controlled synthetic trading entities.

In one embodiment, the dynamic bid and ask columns 124, 126 display the lasted traded or best bid and ask using the color display scheme (e.g., yellow, red, green, etc.) discussed for the dynamic price column 68 above.

FIG. 14 further illustrates exemplary ABV windows that include an additional graphical Synthetics button 130 that allows a trader to select the button to return to the specialized Synthetic entity trading window 86 to enter two or more real trading entities that comprise the synthetic trading entity.

The methods and system described herein are described with using two real trading entities comprising one synthetic trading entity. However, the present invention is not limited to two real trading entities and more that two read trading entities can be used to practice the invention.

The method and system described herein provide for automatic execution of risk-controlled synthetic trading entities. Risk parameters are generated for two or more real trading entities that comprise a synthetic trading entity. Risk assessments are generated for the resulting synthetic trading entity from the risk parameters. Current and historical trading information is used to generate the risk parameters and risk assessments. Market prices for the real trading entities to keep the automatic risk-controlled synthetic trading entity at a desired synthetic market price level whenever selected risk assessments exceed one or more pre-determined risk thresholds.

It should be understood that the architecture, programs, processes, methods and systems described herein are not related or limited to any particular type of computer or network system (hardware or software), unless indicated otherwise. Various types of general purpose or specialized computer systems may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams.

While various elements of the preferred embodiments have been described as being implemented in software, in other embodiments hardware or firmware implementations may alternatively be used, and vice-versa.

The claims should not be read as limited to the described order or elements unless stated to that effect. In addition, use of the term “means” in any claim is intended to invoke 35 U.S.C. §112, paragraph 6, and any claim without the word “means” is not so intended.

Therefore, all embodiments that come within the scope and spirit of the following claims and equivalents thereto are claimed as the invention.

We claim:

1. A method for automatically executing risk-controlled synthetic trading entities, comprising:
automatically generating a first real trading order for a first real trading entity for an automatic risk-controlled synthetic trading entity on a first electronic trading exchange via a trading application on a target network device with one or more processors via a communications network, wherein the synthetic trading entity includes two or more real trading entities;
automatically generating a second trading order for a second real trading entity of the automatic risk-controlled synthetic trading entity on a second electronic trading exchange via the trading application on the target network device;
automatically generating a first set of synthetic trading entity risk parameters for the first real trading order considering current and historical market depth information;
automatically generating a set of second synthetic trading entity risk parameters for the second real trading order considering current and historical market depth information;
automatically generating a set of synthetic trading entity risk assessments for the risk-controlled synthetic trading entity using the generated first set of synthetic trading entity risk parameters and the generated second set of synthetic trading entity risk parameters and current and historical trading information the synthetic trading entity; and
automatically readjusting a first desired market price for the first real trading order or a second desired market price for the second real trading order to keep the automatic risk-controlled synthetic trading entity at a desired synthetic market price level whenever one or more of the set of synthetic trading entity risk assessments exceeds one or more pre-determined risk thresholds.

2. A computer readable medium have stored therein a plurality of instructions for causing one or more processors to execute the steps of the method of claim 1.

3. The method of claim 1 wherein the synthetic trading entity includes a synthetic contract or a synthetic financial instrument.

4. The method of claim 3 wherein the synthetic contract includes a synthetic futures contract, a synthetic financial instrument contract or a synthetic cash instrument contract.

5. The method of claim 1 further comprising:
displaying via the trading application via a multi-windowed application with a graphical user interface an Aggregated Book View/Ask Bid Volume (ABV) window for displaying one or more real trading entities and one or more synthetic trading entities, wherein the ABV window includes a dynamic price column that displays a market depth for the automatic risk-controlled synthetic trading entity, a market depth for the first real trading order and the second real trading order of the automatic risk-controlled synthetic trading entity and one or more generated synthetic trading entity risk factors for electronic trades being executed for the automatic risk-controlled synthetic trading entity.

8. The method of claim 1 wherein trading information first real trading order and the second real trading order is input via the trading application via graphical window including an Aggregated Book View/Ask Bid Volume (ABV) window or a Synthetic Entity Trading window, wherein the ABV window includes a graphical button for displaying the Synthetic Entity trading window when selected.

9. The method of claim 1 further comprising:
displaying via the trading application via a multi-windowed application with a graphical user interface an Aggregated Book View/Ask Bid Volume (ABV) window for displaying one or more real trading entities and one or more synthetic trading entities, wherein the ABV window includes a selection mode for selecting a dynamic price column that that dynamically, continuously and automatically a last trade price and displays a market depth for the automatic risk-controlled synthetic trading entity, a dynamic bid column that dynamically, continuously and automatically displays a last traded or best bid for the automatic risk-controlled synthetic trading entity, or a dynamic ask column that that dynamically, continuously and automatically displays a last traded or best ask for the automatic risk-controlled synthetic trading entity, a market depth for the first real trade and the second real trade of the automatic risk-controlled synthetic trading entity and one or more generated synthetic trading entity risk factors.

10. The method of claim 1 wherein the set of synthetic trading entity risk assessments are automatically and dynamically determined based on dynamic or static risk management trading value amounts currently being used for a pre-determined risk hierarchy.

11. The method of claim 1 wherein the pre-determined risk hierarchy includes a is an account hierarchy that includes a trading firm trading firm office and trading account hierarchy for first and second real trading entities and for the synthetic trading entity.

12. The method of claim 1 wherein the pre-determined hierarchy includes a hierarchy comprising current trading positions, historical trading activity and trading account margins for first and second real trading entities and for the synthetic trading entity.

13. The method of claim 1 wherein the first and second set of synthetic trading entity risk parameters are generated using maximum absolute position value by all trading accounts on all electronic trading exchanges, absolute net position change by all trading accounts on all electronic trading exchanges, total change in all positions in all trading accounts in all electronic trading exchanges, total account value decline of greater than a pre-determined threshold or total trade volume and net profit and loss.

14. The method of claim 1 wherein the set of synthetic trading entity risk assessments is generated using total account values, prior historical trading histories or current trading histories across all trading accounts with all trading brokers.

15. The method of claim 1 wherein the pre-determined risk thresholds include a market depth risk threshold for the first real trading order or the second real trading order.

16. The method of claim 1 wherein the pre-determined risk thresholds includes synthetic trade risk threshold dynamically and automatically calculated in real-time using statistical modeling for current and historical trading of the synthetic trading entity.

17. A system for automatically executing risk-controlled synthetic trading entities, comprising in combination:
means for automatically generating a first real trading order for a first real trading entity for an automatic risk-controlled synthetic trading entity on a first electronic trading exchange via a trading application on a target network device with one or more processors via a communications network, wherein the synthetic trading entity includes two or more real trading entities;
means for automatically generating a second trading order for a second real trading entity of the automatic risk-controlled synthetic trading entity on a second electronic trading exchange via the trading application on the target network device;
means for automatically generating a first set of synthetic trading entity risk parameters for the first real trading order considering current and historical market depth information;
means for automatically generating a set of second synthetic trading entity risk parameters for the second real trading order considering current and historical market depth information;
means for automatically generating a set of synthetic trading entity risk assessments for the risk-controlled synthetic trading entity using the generated first set of synthetic trading entity risk parameters and the generated second set of synthetic trading entity risk parameters and current and historical trading information the synthetic trading entity; and
means for automatically readjusting a first desired market price for the first real trading order or a second desired market price for the second real trading order to keep the automatic risk-controlled synthetic trading entity at a desired synthetic market price level whenever one or more of the set of synthetic trading entity risk assessments exceeds one or more pre-determined risk thresholds.

18. The system of claim 17 further comprising:
means for displaying via the trading application via a multi-windowed application with a graphical user interface an Aggregated Book View/Ask Bid Volume (ABV) window for displaying one or more real trading entities and one or more synthetic trading entities, wherein the ABV window includes a dynamic price column that displays a market depth for the automatic risk-controlled synthetic trading entity, a market depth for the first real trading order and the second real trading order of the automatic risk-controlled synthetic trading entity and one or more generated synthetic trading entity risk factors for electronic trades being executed for the automatic risk-controlled synthetic trading entity.

19. The system of claim 17 further comprising:
means for creating a first pre-determined risk threshold comprising a market depth risk threshold for the first real trading order or the second real trading order.

20. The system of claim 17 further comprising:
means for creating a second pre-determined risk threshold comprising dynamically and automatically calculating the second pre-determined risk threshold in real-time using statistical modeling of current and historical trading of the synthetic trading entity.
